(19) United States
(12) Patent Application Publication
(10) Pub. No.: US 2012/0313345 A1
(43) Pub. Date: Dec. 13, 2012

(54) Tow Bar System

(76) Inventors: Arnold Kamler, Montville, NJ (US); Jonathan Singer, Tenafly, NJ (US)

(21) Appl. No.: 13/489,869

(22) Filed: Jun. 6, 2012

Related U.S. Application Data
(60) Provisional application No. 61/494,161, filed on Jun. 7, 2011.

(51) Int. Cl. B60D 1/00

(52) U.S. Cl. 280/292

(57) ABSTRACT

A tow bar system for coupling a bicycle to a wheeled trolley is provided. The tow bar system includes a first portion, a second portion, a trailer arm and a wheel. The first portion is configured to be removably coupled to the bicycle. The second portion is configured to be removably coupled to the wheeled trolley. The trailer arm extends between the first and second portions and at least a portion of the trailer arm having a substantially arc shape to avoid contact with the bicycle. The wheel is coupled to at least one of the second portion and the trailer arm

### CROSS-REFERENCE TO RELATED APPLICATION

This application claims benefit of U.S. Provisional Application No. 61/494,161, filed Jun. 7, 2011, which is hereby incorporated herein by reference in its entirety.

### FIELD

The present application relates to a tow bar system, such as for towing a wheeled trolley, and more particularly, a tow bar system for towing a wheeled trolley, such as a jogging stroller, behind a bicycle.

### BACKGROUND

Strollers and trolleys are popular for transporting children and individuals with restricted mobility. In this regard, a number of different types of strollers and trolleys have been developed for specialized purposes. For example, standard strollers have been developed for general use such as walking while more specialized strollers have been developed for jogging and other activities. Further, additional strollers have been developed for use as trailers which are towed behind a bicycle.

In view of the degree of specialization of strollers, if a parent wishes to do a variety of activities with his or her child, it might be necessary to have a number of cumbersome strollers and trailers. For example, a parent may have one or more standard strollers for general use along with a jogging stroller for jogging and a bicycle stroller or trailer for bike riding. Having such a large number of strollers and trailers may take up significant room and possibly add further expense.

Therefore, it may be desirable to have an adapter suitable to convert specialized strollers such that the strollers may be suitable for multiple uses. For example, it may be desirable to provide an adapter, such as a tow bar, which may be suitable for use with a large number of different jogging strollers to convert the jogging strollers for use as a trailer or cart pulled behind a bicycle.

### SUMMARY

In one form, a tow bar system for coupling a bicycle to a wheeled trolley is provided. The tow bar system includes a first portion, a second portion, a trailer arm and a wheel. The first portion is configured to be removably coupled to the bicycle. The second portion is configured to be removably coupled to the wheeled trolley. The trailer arm extends between the first and second portions with at least a portion of the trailer arm having a substantially arc shape to avoid contact with the bicycle. Further, the wheel is coupled to at least one of the second portion and the trailer arm.

According to one form, a tow bar system for coupling a bicycle to a wheeled trolley is provided. The tow bar system includes a first portion, a second portion and a trailer arm. The first portion is configured to be removably coupled to the bicycle. The first portion includes a first pivot to permit at least a portion of the tow bar system to pivot about at least two axes relative to the bicycle. The second portion is configured to be removably coupled to the wheeled trolley. The trailer arm extends between the first and second portions. At least a portion of the trailer arm has a substantially arc shape to avoid contact with the bicycle.

In accordance with one form, the tow bar system further includes a first pivot located at the first portion to permit at least a portion of the tow bar system to pivot relative to the bicycle.

In one form, the first pivot is a universal joint.

According to one form, the tow bar system further includes a second pivot located at the second portion to permit at least a portion of the tow bar system to pivot relative to the wheeled trolley.

In accordance with one form, the tow bar system further includes a suspension.

In one form, the wheel is in a fixed position relative to the trailer arm.

According to one form, the tow bar system further includes a quick release at the first portion to removably couple the tow bar system to the bicycle.

In accordance with one form, the tow bar system further includes at least one clamp at the second portion to removably couple the tow bar system to the wheeled trolley.

In one form, the tow bar system further includes a mud flap.

These and other aspects may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side perspective view of a bicycle coupled to a jogging stroller via a tow bar system;

FIG. 2 is a an enlarged view of a portion of the tow bar system of FIG. 1;

FIG. 3 is an enlarged view of a portion of a tow bar system coupled to a bicycle;

FIG. 4 is a partially exploded view of a portion of a tow bar system;

FIG. 5 is a side perspective view of a portion of the tow bar system for coupling to a wheeled trolley;

FIG. 6 is a rear perspective view of the portion of the tow bar system for coupling to a wheeled trolley as shown in FIG. 5;

FIG. 7 is a perspective view of the portion of the tow bar system for coupling to a wheeled trolley;

FIG. 8 is a perspective view of the portion of the tow bar system for coupling to a wheeled trolley;

FIG. 9 is a side perspective view of a portion of a trailer arm of the tow bar system; and

FIG. 10 is an exploded view of a first portion of the tow bar system for coupling to a bicycle.

### DETAILED DESCRIPTION

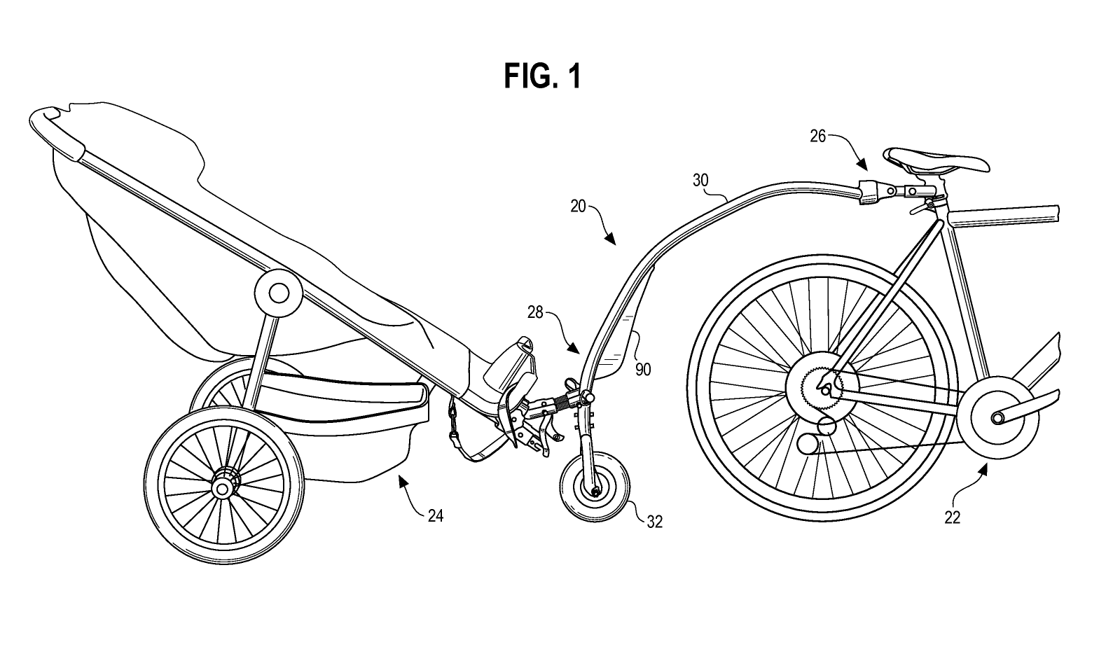

Referring to FIG. 1, there is illustrated a tow bar system 20 coupling a bicycle 22 to a wheeled trolley 24, such as a jogging stroller. The tow bar system 20 may be used with a variety of bicycles and wheeled trolleys as understood from the attached figures and as described herein. The tow bar system 20 generally includes a first portion 26, a second portion 28, a trailer arm 30 and a wheel 32.

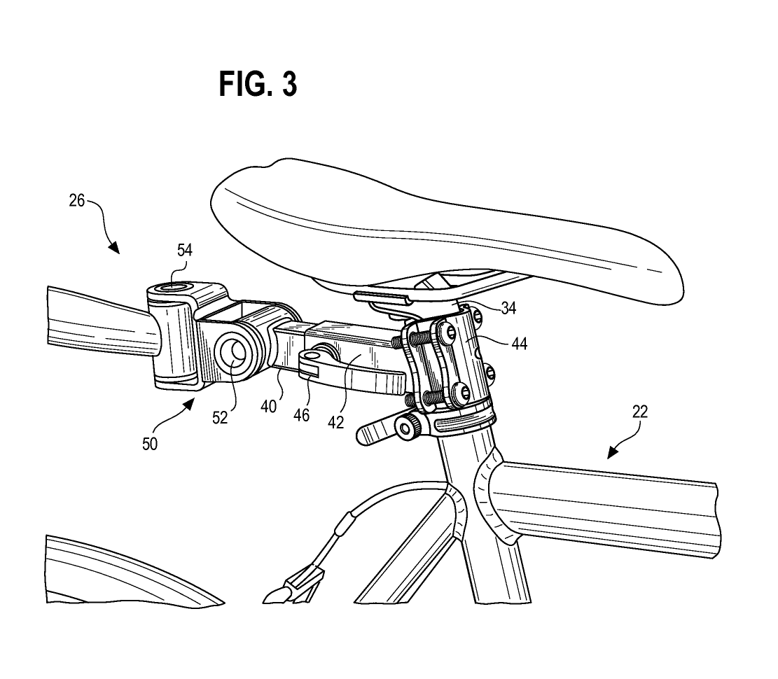

As illustrated in FIGS. 1 and 3, the tow bar system 20 is removably coupled to the bicycle 22 via the first portion 26. The first portion 26 may be coupled to the bicycle 22 in a variety of manners and in a number of different locations. For example, as illustrated in FIG. 3, the first portion 26 is coupled to a seat post 34 of the bicycle 22. However, the tow bar system may be coupled to other portions of the bicycle, such as the frame and other portions.

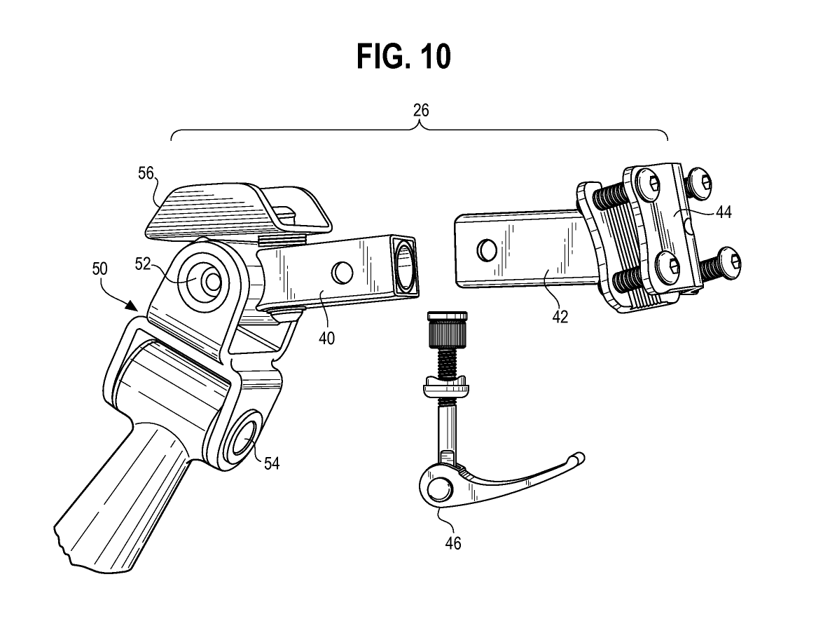

In one form, as seen in FIG. 3, the first portion 26 includes a male connector 40 and a female connector 42. The female connector 42 is configured to receive the tow arm male connector 40 therein. According to one form, the female connector 42 is configured to be attached to a portion of the bicycle 22, such as the seat post 34. In this regard, the female connector includes a seat post clamp 44. In one form, such as seen in FIG. 10, the first portion 26 may include a quick release 46 so the male connector 40 may be quickly disconnected from the female connector 42 to separate the tow bar system 20 from the bicycle 22. It should be understood that other forms of connectors may be used to couple the tow bar system 20 to the bicycle 22.

The first portion 26 may further include structure configured to permit the tow bar 20 to pivot. In one form, the first end 26 may include structure to allow the tow bar to pivot about at least two axes. As best seen in FIGS. 3 and 10, in one form, the first portion 26 includes at least one pivot point 50 such as in the form of two pivot joints 52,54. In this regard, the first portion 26 may include a universal joint or other similar structure to permit movement of the tow bar system 20 relative to the bicycle 22. For example, as the bicycle 22 turns around a corner or begins ascending or descending a slope, the pivot point 50 permits the bicycle 22 to pivot relative to the tow bar system 20 and/or the wheeled trolley 24. This pivoting motion may help lower the amount of stress placed on the bicycle 22, tow bar system 20 and wheeled trolley 24.

Further, in one form, such as seen in FIG. 10, the first portion 26 may also include a movement limiting device, such as a stopper 56, to limit overrotation at the pivot 50. In this regard, the first portion 26 and/or the trailer arm 30 may contact the stopper 56 to prevent damage to the tow bar system 20, the bicycle 22 or the wheeled trolley 24. It should be understood that other forms of pivots, connectors, stoppers and the like may be used as part of the first portion 26 of the tow bar system 20.

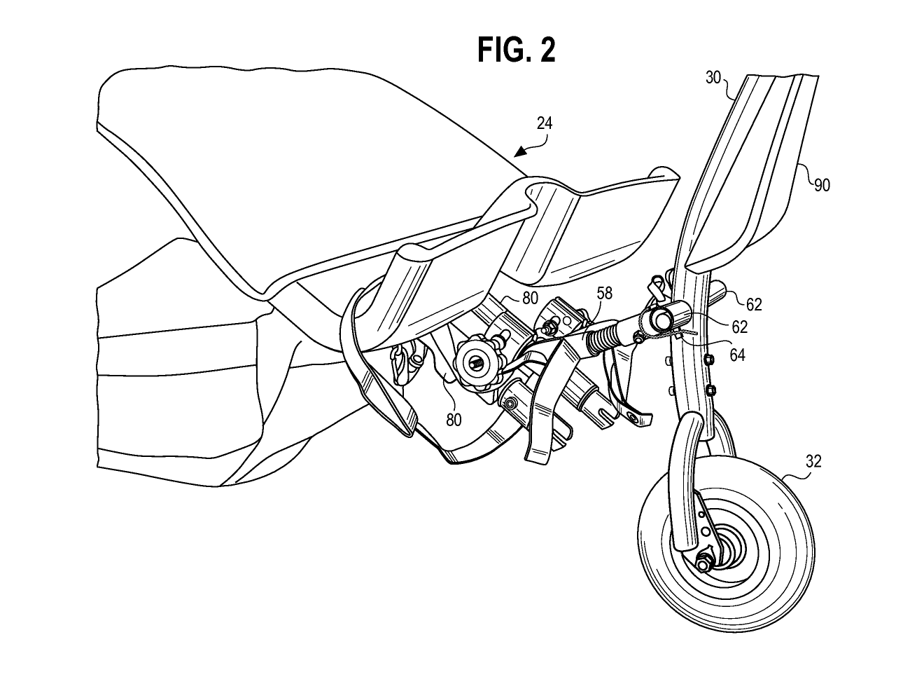

The tow bar system 20 also includes the second portion 28 which is configured to be removably coupled to the wheeled trolley 24, such as illustrated in FIG. 2. In one form, the second portion 28 includes at least one coupling arm 58. As seen in FIG. 2, the tow bar system 20 may include two coupling arms 58. However, it should be noted that a single coupling arm or more than two coupling arms may be configured for use in the tow bar system 20.

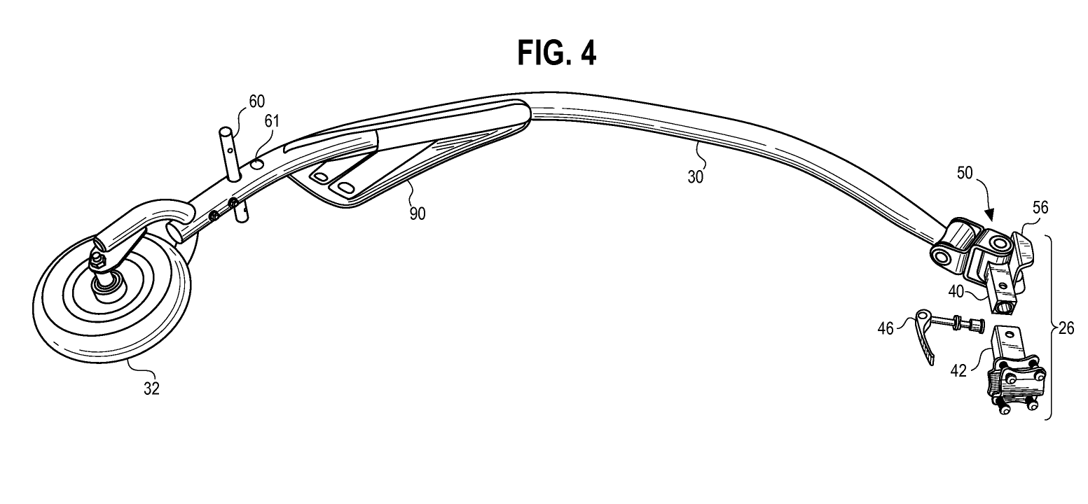

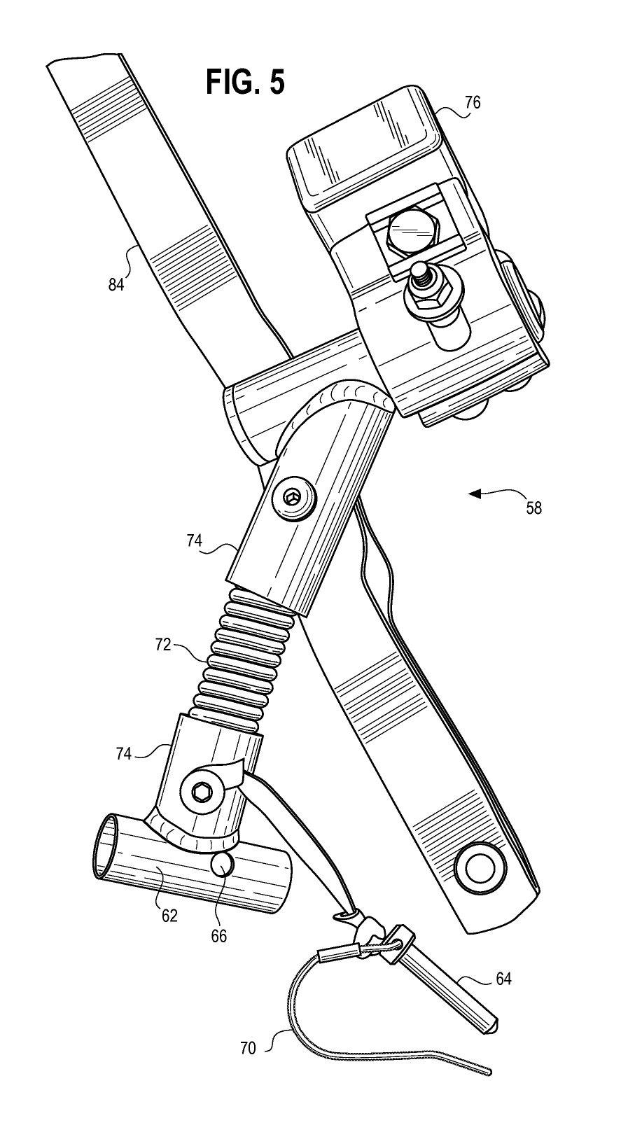

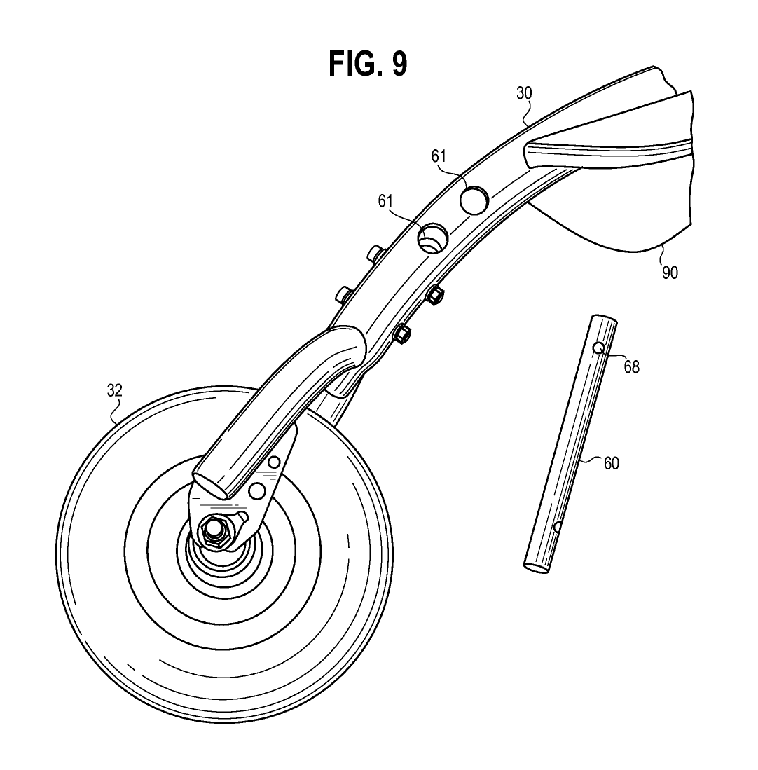

Further, as seen in FIG. 4, in one form, the second portion 28 includes an axle 60 which is configured to be inserted through an opening 61 in the tow bar system 20 and coupled to one or more axle sleeves 62 on the coupling arms 58. In one form, such as shown in FIG. 9, the tow bar system 20 include multiple openings 61 to thereby permit adjustment of the location of the axle 60. For example, if the wheeled trolley 24 is larger or smaller, the axle may be positioned in different openings 61 to accommodate a preferred orientation and positioning of the wheeled trolley with respect to the tow bar system 20. Any number of differently located openings may be included to permit adjustment of the axle 60.

As illustrated in the figures, in one form, two axle sleeves 62 are provided such that each of the two axle sleeves 62 is coupled to an opposite end of the axle 60. It should be understood that the axle 60 and axle sleeves 62 may be removably coupled together or otherwise permanently secured to one another. For example, the axle 60 and axle sleeve 62 may include a pin 64 to prevent the axle and axle sleeve from inadvertently separating when in use. In this regard, the pin 64 will insert through openings 66 in the axle sleeve 62 and an opening 68 in the axle to thereby secure the axle 60 and axle sleeve 62 relative to one another. The pin 64 may also include a safety device 70 to help secure the pin 64. Alternatively, the axle 60 may be permanently secured to the axle sleeve 62, such as by being welded together.

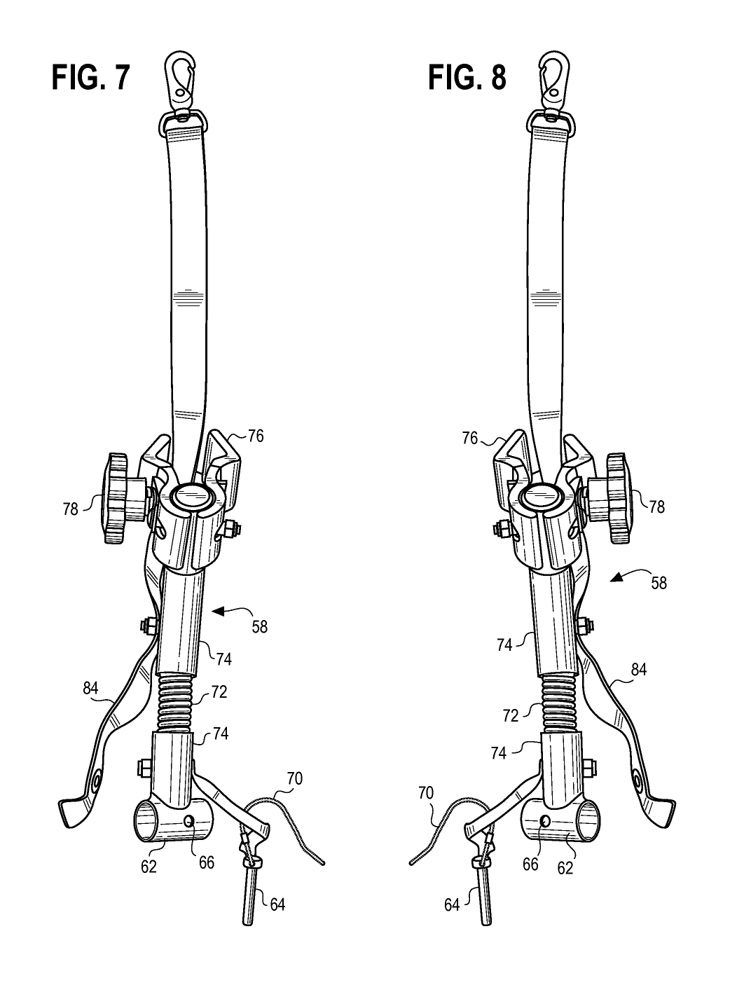

Further, the second portion 28 may include one or more suspension springs 72 and spring sleeves 74. The springs 72 may permit the second portion 28 and the attached wheeled trolley 24 to pivot or otherwise move relative to the bicycle 22 and/or tow bar system 20, such as when the bicycle 22 is turning or ascending or descending an incline. In one form, such as shown in FIGS. 7 and 8, the springs 72 and spring sleeves 74 may be located on the coupling arms 58 such that the coupling arms 58 include a flexible joint to permit a portion of the coupling arms 58, such as the axle sleeves 62, to move relative to other portions of the coupling arms 58.

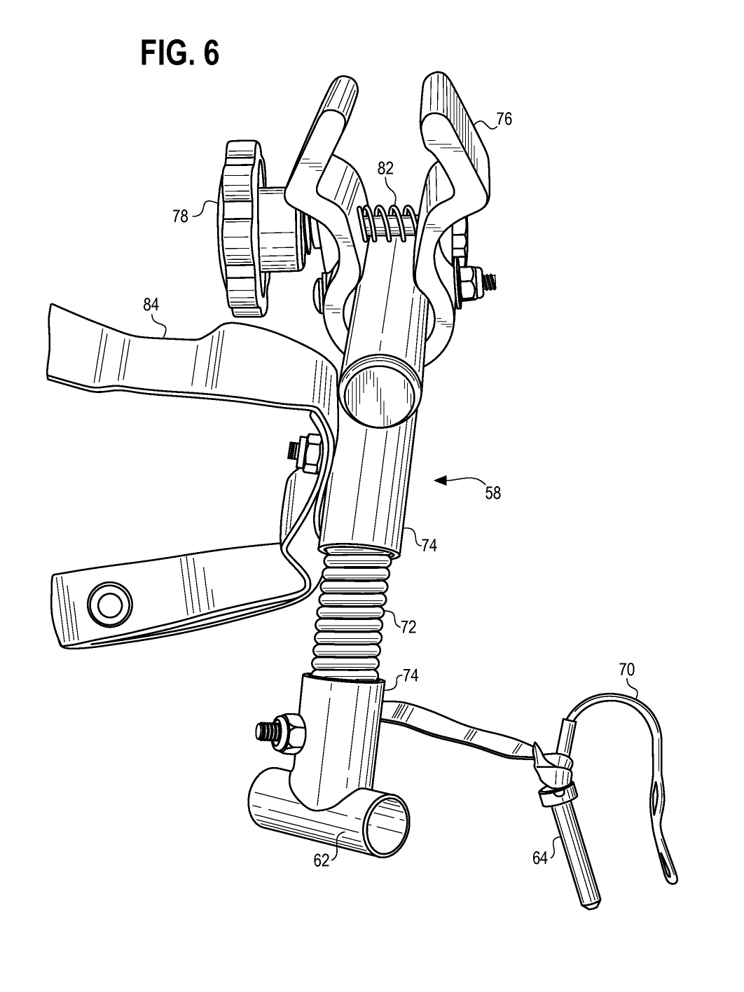

The second portion 28 may also include one or more attachment structures, such as clamps or other structures for coupling the tow bar system 20 to the wheeled trolley 24 or jogging stroller. For example, in one form as shown in FIG. 6, the second portion 28 may include a clamp 76 and a clamp adjuster knob 78. The adjuster knob 78 can be used to compress the clamp 76 as understood from the figures.

In one form, as shown in the figures, the clamp 76 is a fairly universal clamp that may be used on a variety of different wheeled trolleys and jogging strollers. In this regard, the clamps 76 may be adjusted to couple to a wheel axle, fork or other structure of the jogging stroller. For example, referring to FIG. 2, the two clamps 76 are secured to the frame/forks 80 of the wheeled trolley 24. The clamp 76 may also include a tension spring 82 assist in spreading the clamp apart as the adjuster knob 78 is loosened.

In one form, such as shown in FIG. 2, the wheeled trolley 24 is a jogging stroller that generally includes a front wheel (not shown). When used with the tow bar system 20, it may desirable to remove the front wheel to permit greater movement of the wheeled trolley 24 relative to the bicycle 22. The movement may be provided by the pivot point 50 and/or the suspension springs 72. In this regard, the structures function as a suspension system to minimize bumps and jarring that might otherwise occur thereby helping to provide a softened ride between the wheeled trolley 24 and the bicycle 22. However, it should be understood that if the wheeled trolley or stroller includes a front wheel, it may not be necessary to be removed. In this form, where the front wheel is not removed, it may not be necessary to include the wheel 32 in the tow bar system 20.

The second portion 28 may also include other features. For example, the second end 28 may include one or more safety straps 84 that can be used to prevent the wheeled trolley 24 from breaking away from the tow bar system 20 in case the clamp 76 accidentally separates from the wheeled trolley 24 or some other separation occurs.

As illustrated in FIGS. 1 and 4, the tow bar system 20 includes the trailer arm 30 extending between the first and second portions 26,28. The trailer arm 30 may take a variety of shapes. For example, as illustrated in FIG. 1, the trailer arm 30 is generally arc shaped. It should be understood that the trailer arm 30 may include any number of differently shaped portions, such as straight or angled portions as well as substantially arc shaped portions. The trailer arm 30 may be shaped and sized to accommodate any number of different bicycles as well as configured to attach to a number of different positions on the bicycle. In one form, the trailer arm 30 is shaped such that when installed to a bicycle seat post, the trailer arm is clear to pivot about a rear bicycle wheel.

Further, the tow bar system 20 may include the wheel 32, such as shown in FIG. 2. As seen in this figure, the wheel 32 is fixed relative to the trailer arm 30. In this form, the second portion 28 permits relative movement of the wheeled trolley 24 relative to the wheel 32 and trailer arm 30. Alternatively, it should be understood that the wheel 32 may take the form as more of a caster-type wheel whereby the wheel is permitted to move relative to the trailer arm 30. In this form, the trailer arm 30 may first move in a direction and the caster-type wheel will follow, but is permitted to rotate relative to the trailer arm 30. The tow bar system wheel 32 may be used in conjunction with the existing wheels on the wheeled trolley 24 or the stroller may have one or more wheels removed, such as shown in FIG. 2. Alternatively, the wheel 32 in the tow bar system may be omitted.

The tow bar system 20 may also include other features. For example, the tow bar system 20 may include a mud flap 90, such as shown in FIG. 4. The mud flap 90 may be used to cut down on the amount of water, mud and other debris that may be kicked up by the bicycle 22 towards the wheeled trolley 24 when in use.

The tow bar system 20 may be installed for use as understood from the figures and description herein. For example, the female connector 42 may be secured to the bicycle 22 in a semi-permanent manner such that the male connector 40 may be quickly connected and disconnected to the bicycle. In this regard, the tow bar system 20 may be quickly installed and uninstalled from the bicycle so a user can quickly convert to and from towing a wheeled trolley. The tow bar system 20 may also be quickly connected and disconnected to the wheeled trolley 24. For example, the clamps 76 may be used to quickly connect and disconnect the wheeled trolley 24 to the tow bar system 20. Furthermore, the coupling arms 58 may be quickly connected and disconnected to the axle 60 such that different trolleys having different coupling arms 58 may be connected and disconnected to the trailer arm 30.

The tow bar system may be constructed of a variety of different materials. For example, the first portion, second portion and trailer arm may be made of a variety of different materials such as metal, plastic and the like. In one form, the first portion, second portion and trailer arm are made of materials including steel, aluminum, titanium, carbon fiber and combinations thereof. The tow bar system and associated components may also be made of other materials as understood from the present description and figures.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A tow bar system for coupling a bicycle to a wheeled trolley, the tow bar system comprising:
a first portion configured to be removably coupled to the bicycle;
a second portion configured to be removably coupled to the wheeled trolley;
a trailer arm extending between the first and second portions, at least a portion of the trailer arm having a substantially arc shape to avoid contact with the bicycle; and
a wheel coupled to at least one of the second portion and the trailer arm.

2. The tow bar system of claim 1 further comprising a first pivot located at the first portion to permit at least a portion of the tow bar system to pivot relative to the bicycle.

3. The tow bar system of claim 2 wherein the first pivot is a universal joint.

4. The tow bar system of claim 1 further comprising a second pivot located at the second portion to permit at least a portion of the tow bar system to pivot relative to the wheeled trolley.

5. The tow bar system of claim 1 further comprising a suspension.

6. The tow bar system of claim 1 wherein the wheel is in a fixed position relative to the trailer arm.

7. The tow bar system of claim 1 further comprising a quick release at the first portion to removably couple the tow bar system to the bicycle.

8. The tow bar system of claim 1 further comprising at least one clamp at the second portion to removably couple the tow bar system to the wheeled trolley.

9. The tow bar system of claim 1 further comprising a mud flap.

10. A tow bar system for coupling a bicycle to a wheeled trolley, the tow bar system comprising:
a first portion configured to removably coupled to the bicycle, the first portion including a first pivot to permit at least a portion of the tow bar system to pivot about at least two axes relative to the bicycle;
a second portion configured to be removably coupled to the wheeled trolley; and
a trailer arm extending between the first and second portions, at least a portion of the trailer arm having a substantially arc shape to avoid contact with the bicycle.

11. The tow bar system of claim 10 further comprising a wheel coupled to at least one of the second portion and the trailer arm.

12. The tow bar system of claim 10 wherein the first pivot is a universal joint.

13. The tow bar system of claim 10 further comprising a second pivot located at the second portion to permit at least a portion of the tow bar system to pivot relative to the wheeled trolley.

14. The tow bar system of claim 10 further comprising a suspension.

15. The tow bar system of claim 10 wherein the wheel is in a fixed position relative to the trailer arm.

16. The tow bar system of claim 10 further comprising a quick release at the first portion to removably couple the tow bar system to the bicycle.

17. The tow bar system of claim 10 further comprising at least one clamp at the second portion to removably couple the tow bar system to the wheeled trolley.

18. The tow bar system of claim 10 further comprising a mud flap.
